(19) United States
(12) Patent Application Publication
(10) Pub. No.: US 2021/0176198 A1
(43) Pub. Date: Jun. 10, 2021

(54) DYNAMICALLY DETERMINING RECIPIENTS OF ELECTRONIC MESSAGES

(71) Applicant: LENOVO Enterprise Solutions (Singapore) PTE. LTD., New Tech Park (SG)

(72) Inventors: Gary D. Cudak, Oxford, NC (US); John S. Crowe, Durham, NC (US); Jennifer J. Lee-Baron, Morrisville, NC (US); Nathan J. Peterson, Oxford, NC (US); Amy L. Rose, Chapel Hill, NC (US)

(21) Appl. No.: 16/705,742

(22) Filed: Dec. 6, 2019

(51) Int. Cl. H04L 12/58; H04L 29/08

(52) U.S. Cl. CPC H04L 51/14; H04L 51/34; H04L 67/24

(57) ABSTRACT

Apparatuses, methods, program products, and systems are disclosed for dynamically determining recipients of electronic messages. An apparatus includes a processor and a memory that stores code executable by the processor. The code is executable by the processor to evaluate one or more characteristics of a received electronic message to determine a context of the electronic message. The code is executable by the processor to determine, based on the determined context of the electronic message, one or more users who are target recipients of the electronic message. The code is executable by the processor to forward the electronic message to the determined one or more target recipients.

### FIELD

The subject matter disclosed herein relates to electronic communications and more particularly relates to dynamically determining recipients of electronic messages.

### BACKGROUND

Electronic messages such an emails may be sent to intended recipients who may be unavailable or may not otherwise be able to respond promptly. Within an organization, the lack of a prompt response to an electronic message can negatively impact productivity.

### BRIEF SUMMARY

An apparatus for dynamically determining recipients of electronic messages is disclosed. A method and computer program product also perform the functions of the apparatus. An apparatus, in some embodiments, includes a processor and a memory that stores code executable by the processor. The code, in one embodiment, is executable by the processor to evaluate one or more characteristics of a received electronic message to determine a context of the electronic message. The code, in further embodiments, is executable by the processor to determine, based on the determined context of the electronic message, one or more users who are target recipients of the electronic message. The code, in certain embodiments, is executable by the processor to forward the electronic message to the determined one or more target recipients.

A method, in one embodiment, includes evaluating one or more characteristics of a received electronic message to determine a context of the electronic message. The method, in some embodiments, includes determining, based on the determined context of the electronic message, one or more users who are target recipients of the electronic message. The method, in various embodiments, includes forwarding the electronic message to the determined one or more target recipients.

A program product, in one embodiment, includes a computer readable storage medium that stores code executable by a processor. In one embodiment, the code is executable to evaluate one or more characteristics of a received electronic message to determine a context of the electronic message. In certain embodiments, the code is executable to determine, based on the determined context of the electronic message, one or more users who are target recipients of the electronic message. In further embodiments, the code is executable to forward the electronic message to the determined one or more target recipients.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for dynamically determining recipients of electronic messages;

FIG. 2 is a schematic block diagram illustrating one embodiment of an apparatus for dynamically determining recipients of electronic messages;

FIG. 3 is a schematic block diagram illustrating one embodiment of an apparatus for dynamically determining recipients of electronic messages;

FIG. 4A is a schematic block diagram illustrating one embodiment of a system for dynamically determining recipients of electronic messages;

FIG. 4B is a schematic block diagram illustrating one embodiment of another system for dynamically determining recipients of electronic messages;

FIG. 4C is a schematic block diagram illustrating one embodiment of yet another system for dynamically determining recipients of electronic messages;

FIG. 5 is a schematic flow chart diagram illustrating one embodiment of a method for dynamically determining recipients of electronic messages;

FIG. 6 is a schematic flow chart diagram illustrating one embodiment of another method for dynamically determining recipients of electronic messages; and

FIG. 7 is a schematic flow chart diagram illustrating one embodiment of yet another method for dynamically determining recipients of electronic messages.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in some embodiments, includes a processor and a memory that stores code executable by the processor. The code, in one embodiment, is executable by the processor to evaluate one or more characteristics of a received electronic message to determine a context of the electronic message. The code, in further embodiments, is executable by the processor to determine, based on the determined context of the electronic message, one or more users who are target recipients of the electronic message. The code, in certain embodiments, is executable by the processor to forward the electronic message to the determined one or more target recipients.

In one embodiment, the code is further executable by the processor to determine that the electronic message specifies a target recipient for the electronic message, determine that the specified target recipient is unavailable for receiving the message, and select one or more different target recipients to forward the message to based on the determined context of the electronic message. A different target recipient may be selected in response to the determined context of the message matching contextual data associated with the different target recipient.

In one embodiment, the specified target recipient is determined to be unavailable in response to the specified target recipient having an auto-reply message set up indicating that the specified target recipient is not available for a period of time and/or the specified target recipient is not located in a directory for the organization that the electronic message is sent to.

In one embodiment, the code is further executable by the processor to determine the one or more target recipients of the electronic message based on a comparison of the determined context of the message and contextual data associated with the one or more target recipients. In further embodiments, the contextual data associated with the one or more target recipients comprises a department where the target recipient works within an organization, an education of the target recipient, professional experience for the target recipient, and/or a previous communication history of the target recipient with a sender of the electronic message. In some embodiments, the code is further executable by the processor to dynamically derive contextual data for a target recipient based on analyzing content of previous electronic messages sent to and/or from the target recipient.

In one embodiment, the code is further executable by the processor to determine, based on the determined context of the electronic message, that the electronic message requests a response within a period of time, determine typical response times for a plurality of potential target recipients of the electronic message, and select the one or more target recipients from the plurality of target recipients for the electronic message in response to the one or more target recipients having typical response times that satisfy the period of time for responding to the electronic message.

In one embodiment, a target recipient is selected from the plurality of potential target recipients in response to determining that the target recipient is available to respond to the electronic message. In some embodiments, the number of target recipients that are selected from the plurality of potential target recipients is inversely proportional to the period of time for responding to the electronic message. In various embodiments, the code is further executable by the processor to track, over time, the times for each of the plurality of potential target recipients for responding to a received electronic message and store the response times with other contextual data associated with each of the plurality of potential target recipients.

In one embodiment, the code is further executable by the processor to prompt the one or more target recipients to confirm receiving the electronic message prior to forwarding the electronic message and forward the electronic message to one or more target recipients who confirm receiving the electronic message. In some embodiments, the code is further executable by the processor to notify a sender of the electronic message that the electronic message was forwarded to the one or more target recipients. The notification may include contact information for each of the one or more target recipients.

A method, in one embodiment, includes evaluating one or more characteristics of a received electronic message to determine a context of the electronic message. The method, in some embodiments, includes determining, based on the determined context of the electronic message, one or more users who are target recipients of the electronic message. The method, in various embodiments, includes forwarding the electronic message to the determined one or more target recipients.

In one embodiment, the method includes determining that the electronic message specifies a target recipient for the electronic message, determining that the specified target recipient is unavailable for receiving the message, and selecting one or more different target recipients to forward the message to based on the determined context of the electronic message. A different target recipient may be selected in response to the determined context of the message matching contextual data associated with the different target recipient.

In one embodiment, the method includes determining the one or more target recipients of the electronic message based on a comparison of the determined context of the message and contextual data associated with the one or more target recipients. The contextual data may be dynamically derived for a target recipient based on analyzing content of previous electronic messages sent to and/or from the target recipient.

In one embodiment, the method includes determining, based on the determined context of the electronic message, that the electronic message requests a response within a period of time, determining typical response times for a plurality of potential target recipients of the electronic message, and selecting the one or more target recipients from the plurality of target recipients for the electronic message in response to the one or more target recipients having typical response times that satisfy the period of time for responding to the electronic message.

In one embodiment, a target recipient is selected from the plurality of potential target recipients in response to determining that the target recipient is available to respond to the electronic message. In further embodiments, the number of target recipients that are selected from the plurality of potential target recipients is inversely proportional to the period of time for responding to the electronic message. In some embodiments, the method includes tracking, over time, the times for each of the plurality of potential target recipients for responding to a received electronic message and store the response times with other contextual data associated with each of the plurality of potential target recipients.

A program product, in one embodiment, includes a computer readable storage medium that stores code executable by a processor. In one embodiment, the code is executable to evaluate one or more characteristics of a received electronic message to determine a context of the electronic message. In certain embodiments, the code is executable to determine, based on the determined context of the electronic message, one or more users who are target recipients of the electronic message. In further embodiments, the code is executable to forward the electronic message to the determined one or more target recipients.

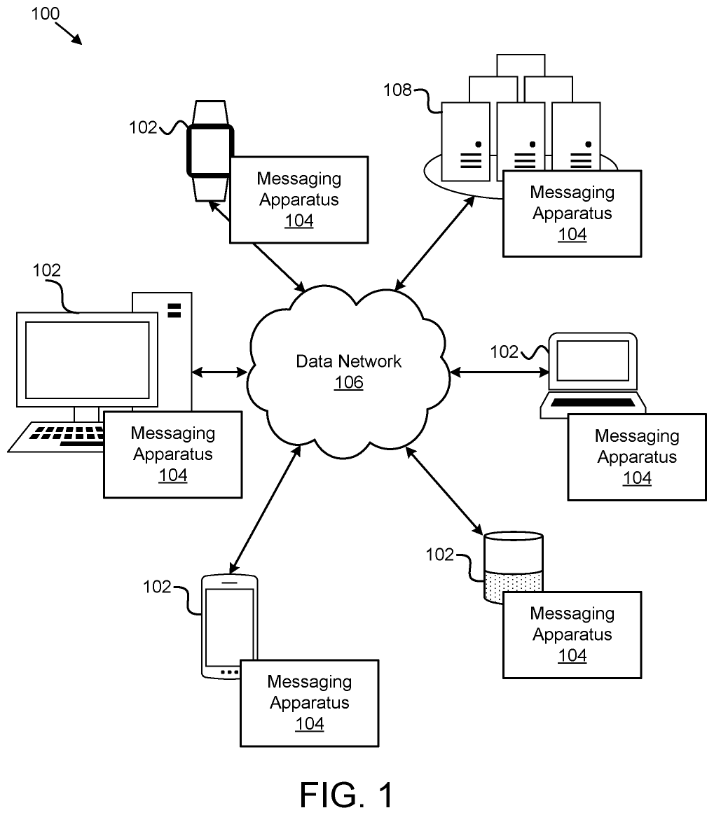

FIG. 1 is a schematic block diagram illustrating one embodiment of a system 100 for dynamically determining recipients of electronic messages. In one embodiment, the system 100 includes one or more information handling devices 102, one or more messaging apparatuses 104, one or more data networks 106, and one or more servers 108. In certain embodiments, even though a specific number of information handling devices 102, messaging apparatuses 104, data networks 106, and servers 108 are depicted in FIG. 1, one of skill in the art will recognize, in light of this disclosure, that any number of information handling devices 102, messaging apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. For instance, the information handling devices 102 may include programs and/or applications for sending and receiving electronic messages such as emails, text messages, short message server (“SMS”) messages, instant messages, push notifications, direct messages (e.g., within an application such as Instagram®), voicemail messages, and/or the like, processing electronic messages (e.g., parsing messages, determining a context of messages using natural language processing, or the like), and/or the like.

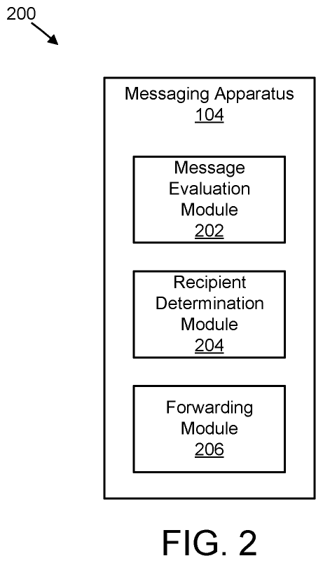

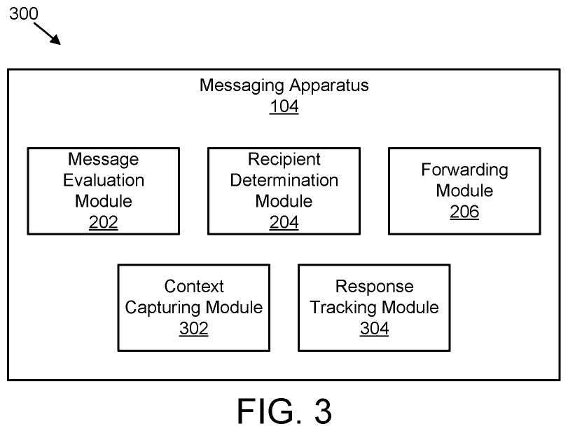

In one embodiment, the messaging apparatus 104 is configured to dynamically determine a recipient of an electronic message based on the context of the message and contextual data associated with the recipient. In one embodiment, the messaging apparatus is configured to evaluate one or more characteristics of a received electronic message to determine a context of the message (e.g., a topic, subject, date, deadline, people, locations, work-related issues, and/or the like), determine one or more users who are target recipients of the message based on the context of the message, and forward the message to the determined target recipients. The messaging apparatus 104, including its various modules, may be located on one or more information handling devices 102 in the system 100, one or more servers 108, one or more network devices, and/or the like. The messaging apparatus 104 is described in more detail below with reference to FIGS. 2 and 3.

In one embodiment, the messaging apparatus 104 improves upon conventional methods of forwarding messages to recipients because the messaging apparatus 104 dynamically determines recipients for the message based on the context of the message and contextual data associated with the recipients. This may be useful when a message is sent to a general address (e.g., a customer service email address), when a specified recipient is unavailable (e.g., is on vacation) and a different target recipient is dynamically determined, and/or the like. Conventional methods, on the other hand, may rely on rules such as auto-forwarding rules for sending messages to predefined contacts that act as a backup or secondary recipient in place of an unavailable specified recipient are inflexible and time consuming to keep up to date.

In various embodiments, the messaging apparatus 104 may be embodied as a hardware appliance that can be installed or deployed on an information handling device 102, on a server 108, or elsewhere on the data network 106. In certain embodiments, the messaging apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the messaging apparatus 104 may include a power interface, a wired and/or wireless network interface, a graphical interface that attaches to a display, and/or a semiconductor integrated circuit device as described below, configured to perform the functions described herein with regard to the messaging apparatus 104.

The messaging apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the messaging apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the messaging apparatus 104.

The semiconductor integrated circuit device or other hardware appliance of the messaging apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the messaging apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, file transfer protocol (“FTP”) servers, media servers, data servers, web servers, file servers, virtual servers, and/or the like. The one or more servers 108 may be communicatively coupled (e.g., networked) over a data network 106 to one or more information handling devices 102. The servers 108 may comprise back-end servers for various multimedia streaming services, news services, gaming services, and/or the like that are accessible via a mobile application, an application for an Internet of Things device, and/or the like.

FIG. 2 is a schematic block diagram illustrating one embodiment of an apparatus 200 for dynamically determining recipients of electronic messages. In one embodiment, the apparatus 200 includes an instance of a messaging apparatus 104. The messaging apparatus 104 includes one or more of a message evaluation module 202, a recipient determination module 204, and a forwarding module 206, which are described in more detail below.

The message evaluation module 202, in one embodiment, is configured to evaluate one or more characteristics of a received electronic message to determine a context of the electronic message. The electronic message may include an email, a text or SMS message, a push notification, a social media post, a voicemail, an instant message, a chat message, and/or the like. The electronic message may be received at a central server (e.g., a central message server for an organization), a cloud server (e.g., a webmail or social media server), a user's device, and/or the like.

The message evaluation module 202, in certain embodiments, evaluates the electronic message to identify characteristics that indicate context information for the message. The message evaluation module 202, for instance, may parse the message to identify keywords, phrases, names, locations, questions, requests, dates, deadlines, and/or the like. The message evaluation module 202, in some embodiments, performs natural language processing to identify the context information for the message including a tone of the message, a topic of the message, and/or the like.

In certain embodiments, the message evaluation module 202 identifies intended or specified recipients of the electronic message (e.g., recipients that the sender has identified as recipients of the message using email addresses, phone numbers, social media usernames, and/or the like). In some embodiments, the message evaluation module 202 determines whether the message requests a response within a period of time. For example, if the message requests a response to meet a deadline for approval of an invoice, reviewing documents, filing papers, accepting an invitation to a meeting, or the like, the message evaluation module 202 may determine when the deadline is or when the response is requested by based on the message (e.g., the message may specify a particular date for responding (e.g., July 1, next Monday, by 3:00 PM tomorrow, etc.); a time frame such as within the next week, days, hours, etc.; and/or the like).

In one embodiment, based on the context information, the recipient determination module 204 is configured to determine one or more users who are target recipients of the electronic message. For instance, if the message is an email directed to a general mailbox such as a customer service email address, a general inquiry or request email address, or the like for a company, the email may not be addressed to specific recipients. The recipient determination module 204, in such an embodiment, may compare the context information for the message to contextual data for possible recipients of the message.

For example, the recipient determination module 204 may cross-reference various keywords or phrases from the message, a topic of the message, and/or the like with user profile information for various users within an organization. The user profile information may be stored in a central server associated with the organization and may include context information describing a user such as an employee, contractor, vendor, or the like of the organization. For example, a user profile may include information such as a user's resume including educational background (e.g., degrees earned, schools attended, or the like), work experience, project experience, technological background, and/or the like; the user's demographic information; the user's hobbies and interests; the departments that the user has worked in within the organization or in previous organizations; projects that the user has worked on; other users within the organization that the user has worked with; previous communications with the sender of the message; typical response times for user; and/or the like.

In certain embodiments, the recipient determination module 204 selects one or more users as target recipients for the electronic message based on the comparison of the context of the message with the context data for the users. For instance, the recipient determination module 204 may select users as target recipients if the users' context data matches the context of the message above a predefined threshold, e.g., if the users' context data matches a predefined number of keywords or phrases of the message or if the users' educational background or work experience matches a topic of the message. In certain embodiments, the recipient determination module 204 selects a user as a target recipient if the user has a previous communication history with the sender and/or if the user and sender have sent a number of messages back and forth that satisfies a predefined threshold (to indicate that the user and the sender converse, or have conversed, regularly).

In further embodiments, the recipient determination module 204 selects a user as a target recipient in response to the user's educational background, work experience, and/or the like matching or being similar to or related to a determined topic of the message, a question or request within the message, and/or the like. For example, if the message is a customer service inquiry about how to setup a wireless router, users within the organization who work in the technical support group may be selected as target recipients, and/or more particularly users who have experience with wireless routers may be selected (based on the users' context/profile information). However, if the topic of the message is a sales question (e.g., a question related to product costs, delivery, or the like), then the recipient determination module 204 may select users in the sales department as the target recipients, and in particular users who have experience related to the topic of the sales question.

In one embodiment, the recipient determination module 204 is configured to determine whether a target recipient that the message sender specifies (e.g., an intended recipient of an email message) is unavailable. For instance, the recipient determination module 204 may determine that a specified or intended recipient has an auto-reply message set up (e.g., a message that is automatically sent back to the sender in response to receiving the sender's message) and that the auto-replay message indicates that the intended recipient is unavailable for a period of time (e.g., due to vacation, sickness, or the like).

In another embodiment, the recipient determination module 204 determines that an intended recipient of the message is unavailable if the intended recipient cannot be located in a directory for an organization. For example, if the intended recipient is identified based on an email address that has a domain for a company, but the email address is not present in the company's email or address server/database (e.g., Active Directory® server), then the recipient determination module 204 may determine that the intended user is unavailable.

In further embodiments, the recipient determination module 204 determines that an intended recipient of the message is unavailable in response to determining that the intended recipient has not sent a message within a threshold period of time (e.g., hours, days, weeks, or the like), that there is no activity associated with the intended recipient's account within a threshold period of time (e.g., that the user has not accessed a company server or logged into a website or company device, or the like), that the intended recipient's location (as indicated by location sensors associated with the intended recipient's device) indicates that the intended recipient is not at a location where the intended recipient is normally located (e.g., at an office, school, home, or other location associated with the intended recipient), and/or the like.

If the recipient determination module 204 determines that the intended recipient is unavailable, as explained above, then the recipient determination module 204 selects different target recipients to receive the message, based on the context of the message and the contextual data associated with the different target recipients, to increase the likelihood of the sender receiving a response to the message or an action being taken based on the message (e.g., revising documents, sending emails, contacting people, or the like).

In one embodiment, if the message evaluation module 202 determines that the message includes a request for a response within a period of time, the recipient determination module 204 determines typical response times for a plurality of potential target recipients and selects target recipients from the plurality of target recipients who have typical response times (e.g., average response times) that satisfy the period of time for responding to the message. For example, if the message evaluation module 202 determines that the message requests a response within a day, the recipient determination module 204 may determine which target recipients from a pool of potential target recipients (which are selected as potential recipients for receiving the message based on the context of the message and the contextual data for the target recipients) (1) are available to respond to the message and (2) have typical response times that are less than or equal to a day. The typical response times for each potential target recipient may be stored with the contextual data for the target recipients so that the recipient determination module 204 has access to the typical response times.

In certain embodiments, the number of target recipients that are selected from the plurality of potential target recipients is inversely proportional to the period of time for responding to the electronic message. In other words, as the length of time for responding to the message increases, the number of target recipients that the recipient determination module 204 selects decreases. For instance, if a message requests a response within a short deadline like a few hours, the recipient determination module 204 may select more target recipients to forward the message to in order to increase the likelihood of one of the target recipients responding to the message within the short deadline. On the other hand, if the message requests a response within a deadline of a week or longer, the recipient determination module 204 may select less target recipients, who may be target recipients that have contextual information that matches the context of the message better than other potential target recipients and which may provide better, more accurate or on-point responses than other potential target recipients. In certain embodiments, as the deadline gets closer, the recipient determination module 204 may dynamically select new or more target recipients to forward the message to in order to increase the likelihood of receiving a response to the message until a response is received.

In one embodiment, the forwarding module 206 is configured to forward the electronic message to the determined target recipients. The forwarding module 206, in one embodiment, sends the electronic message to the one or more target recipients without any additional information. In certain embodiments, the forwarding module 206 forwards the electronic message to the one or more target recipients with additional information such as why the user was selected as a target recipient (e.g., what contextual data matched between the user and the message).

In certain embodiments, the forwarding module 206 is configured to prompt the target recipients to confirm receiving the electronic message prior to forwarding the electronic message. For instance, the forwarding module 206 may send a different electronic message to the target recipients via a text message, an email message, a push notification, or the like to prompt the target recipients to confirm that they want to receive the electronic message. In response to receiving confirmation from one or more of the target recipients, the forwarding module 206 forwards the electronic message to the one or more target recipients.

In some embodiments, the forwarding module 206 is configured to prompt the message sender for confirmation to forward the message to a different recipient than the intended or specified recipient. For example, if the specified recipient for the electronic message is not available, the forwarding module 206 may prompt the sender to confirm forwarding the message to a different target recipient who may be able to respond to the message. If the forwarding module 206 receives confirmation from the sender of the message to forward the message to a target recipient that is different than the intended recipient, the forwarding module 206 will forward the message to the target recipient.

In further embodiments, the forwarding module 206 is configured to notify the message sender that the electronic message has been forwarded to a target recipient. For instance, the forwarding module 206 may send an email to the message sender to inform the sender who the message was forwarded to, contact information for the recipient that the message was forwarded to, whether the message was forwarded to a different recipient than the intended or specified recipient, when the intended recipient is expected to be available again, the average or typical response time for the recipient who the message was forwarded to, and/or the like.

FIG. 3 is a schematic block diagram illustrating one embodiment of an apparatus 300 for dynamically determining recipients of electronic messages. In one embodiment, the apparatus 300 includes an embodiment of a messaging apparatus 104. The messaging apparatus 104 includes one or more of a message evaluation module 202, a recipient determination module 204, and a forwarding module 206, which are substantially similar to the message evaluation module 202, the recipient determination module 204, and the forwarding module 206 described above with reference to FIG. 2. In further embodiments, the messaging apparatus 104 includes one or more of a context capturing module 302 and a response tracking module 304, which are described in more detail below.

The context capturing module 302, in one embodiment, is configured to dynamically capture, track, monitor, store, and/or the like context information for a user. For instance, the context capturing module 302 may derive contextual data for a user who may be a target recipient of an electronic message by analyzing content of previous electronic message that are sent to and/or received from the target recipient. The content of the message may include contextual information described above such as a topic of the message, individuals mentioned in the message, keywords and/or phrases in the message, products mentioned in the message, requests or questions mentioned in the message, dates mentioned in the message, and/or other references.

The context capturing module 302, in certain embodiments, associates context information that the message evaluation module 202 gathers from a received message with a recipient of the message and may also process a response message from the recipient and/or original or new messages that a user sends for contextual information (using the message evaluation module 202 is some embodiments) to capture and store contextual information for the user.

In one embodiment, the context capturing module 302 analyzes other sources associated with a user to determine contextual information for the user. For example, the context capturing module 302 accesses social media web sites associated with the user to parse or scrape contextual information from the websites and associate the information with the user. For example, the context capturing module 302 may access the user's LinkedIn® profile and parse the information on the webpage to identify the user's educational background, work experience, colleagues, and/or other resume items that can be stored as contextual information in the user's profile. In another example, the context capturing module 302 may access the user's Facebook® or Instagram® feeds to determine the user's hobbies, friends, and/or the like that can be stored as contextual information in the user's profile.

In various embodiments, the context capturing module 302 is located on a server for an organization and has access to incoming and outgoing messages, user profiles containing context information for the users within the organization, and/or other user-specific information such as the user's schedule and/or the like. The context capturing module 302 may be part of a directory service for an organization, such as Active Directory®, which provides it with access to a user's activities within an organization (e.g., accessing files on a company server, sending and/or receiving messages from the company's email domain, and/or the like).

In one embodiment, the response tracking module 304 is configured to track, over time, the response times for each user that may be a target recipient and store the response times with other contextual data associated with the target recipient. For example, the response tracking module 304 can determine the typical response time for a user to respond to a message by determining the time between when a message is received by a user and when a response to the message is sent from the user. The response tracking module 304 may average the response times over a period of time to determine the typical response time for a user.

In certain embodiments, the response tracking module 304 determines keywords, phrases, or other indicators of a received message that impact the response times for a user. For instance, a user may respond more promptly to an email if the subject line of the email includes the word “URGENT” as opposed to an email that includes the phrase “at your earliest convenience.” The recipient determination module 304 may use this information to determine which users to select as target recipients according to the content of the message and other contextual information.

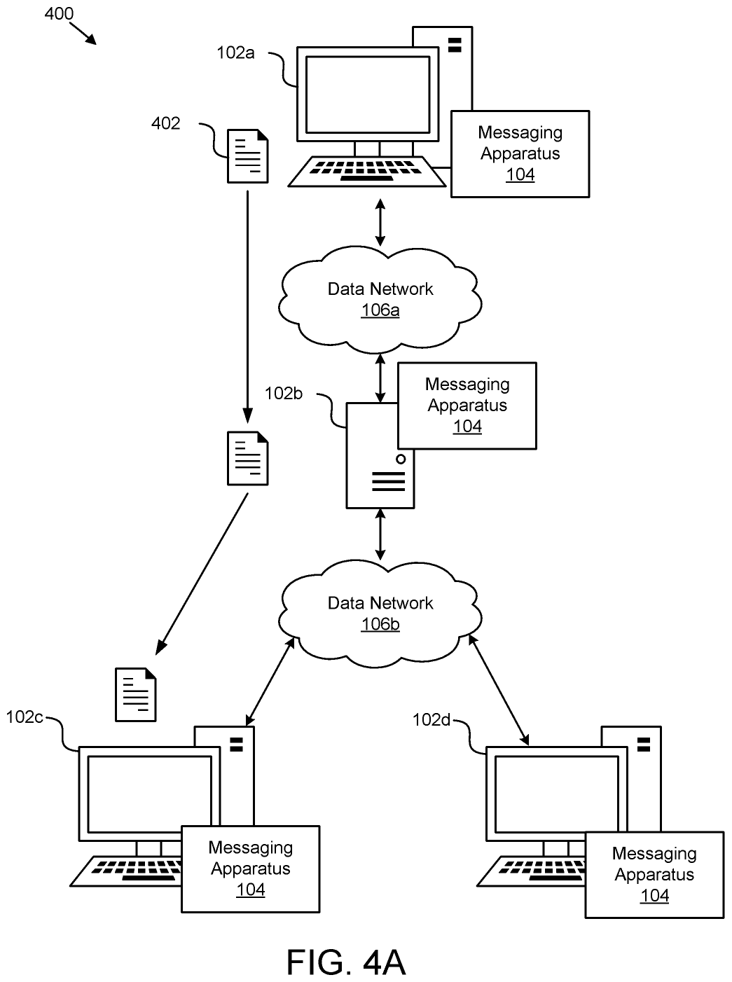

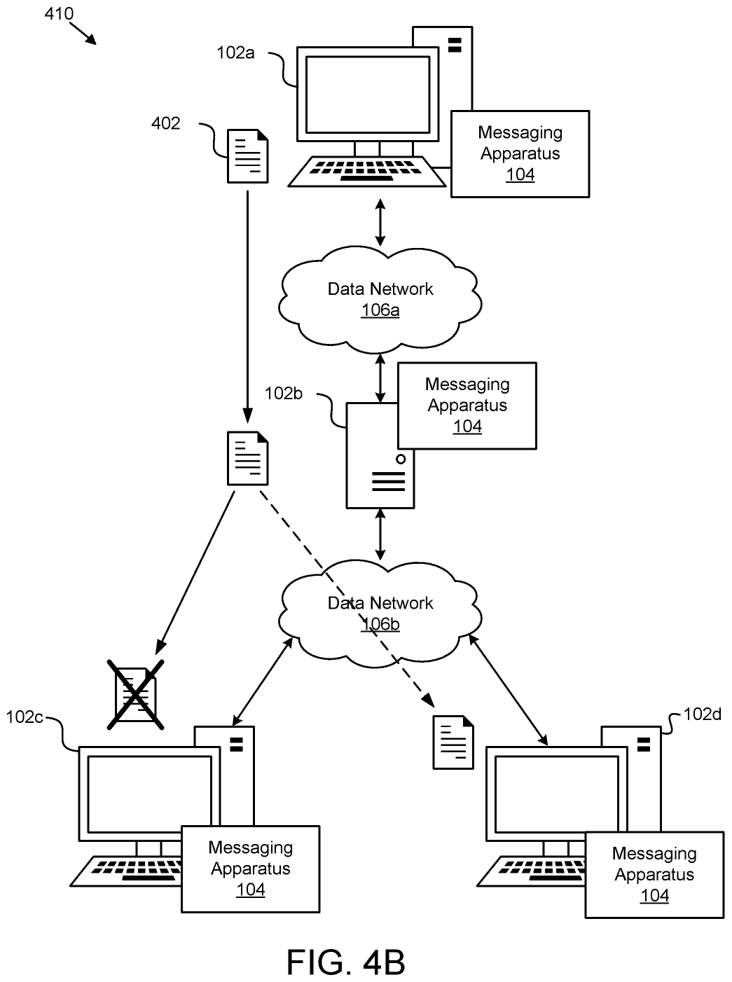

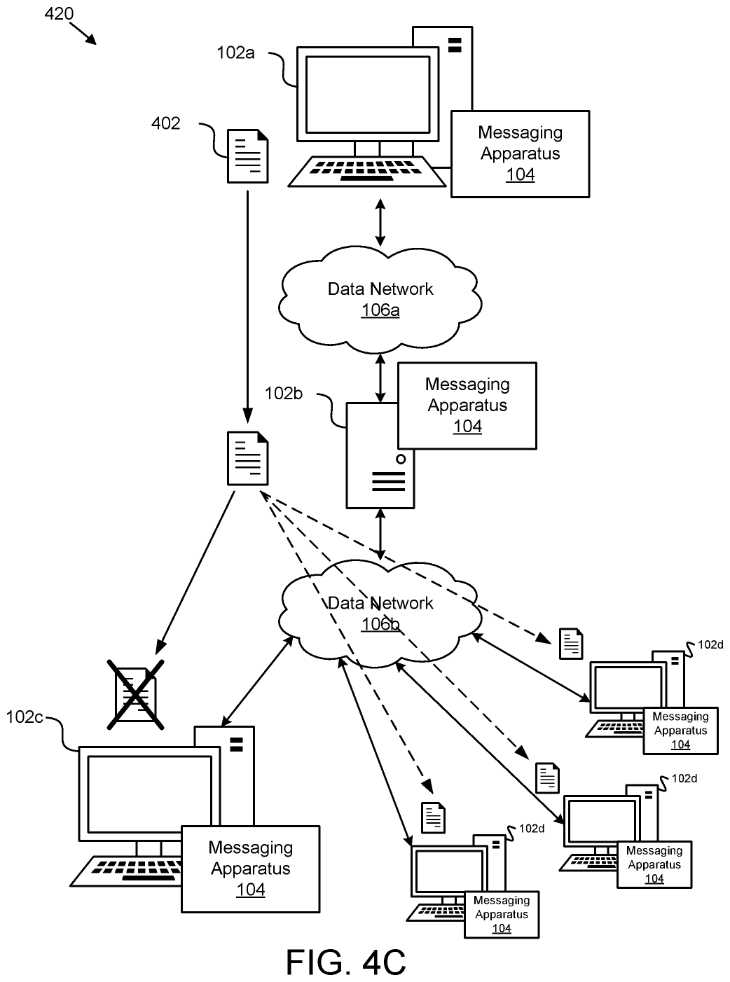

FIG. 4A is a schematic block diagram illustrating one embodiment of a system 400 for dynamically determining recipients of electronic messages. In one embodiment, the system 400 includes a sending device 102a that is used for sending a message 402 from a sender to a recipient at a recipient device 102c, 102d. The message 402 may be received at a central server 102b, e.g., an email server for an organization prior to being forwarded to a recipient 102c, 102d via a data network 106a, which may include the Internet. In certain embodiments, at least a portion of the message apparatus 104 is included in the various devices within the system 400.

In such an embodiment, the message evaluation module 202 at the central server 102b evaluates various characteristics of the message 402 to determine a context of the message. If the message does not specify an intended recipient 102c, 102d, the recipient determination module 204 dynamically determines a recipient 102c, 102d for the message. For example, if the message is sent to a general mailbox for the organization such as a general inquiry email address, a customer service email address, a technical support email address, and/or the like, based on the context of the message, the recipient determination module 204 determines which users within the organization have contextual information that matches the context of the message to determine which users would be most responsive or knowledgeable about the content of the message. The forwarding module 206 may forward the message 402 to the determined target recipient 102c via a data network 106b, which may be an intranet or internal network for the organization.

FIG. 4B is a schematic block diagram illustrating one embodiment of another system 410 for dynamically determining recipients of electronic messages. In one embodiment, the system 410 is substantially similar to the system 400 described above with reference to FIG. 4A. In certain embodiments, the message 402 may specify an intended recipient 102c. For example, the sender 102a may have addressed the message 402 to a particular user 102c within the organization.

In such an embodiment, the recipient determination module 204 at the central server 102b dynamically determines whether the intended recipient 102c is available in response to receiving the message 402 at the central server 102b. The recipient determination module 204 may determine whether the intended recipient 102c has been active within a threshold period of time, whether the intended recipient 102c has an auto-reply message set up, whether the intended recipient 102c is still a valid user within the organization (e.g., whether the intended recipient 102c has left the organization, has a new email address, or the like), and/or the like. If the recipient determination module 204 determines that the intended recipient 102c is not available, then the recipient determination module 204 dynamically determines a target recipient 102d for the message 402 based on the context of the message 402 and contextual information for users within the organization, and the forwarding module 206 forwards the message 402 to the dynamically determined target recipient 102d.

FIG. 4C is a schematic block diagram illustrating one embodiment of yet another system 420 for dynamically determining recipients of electronic messages. In one embodiment, the system 420 is substantially similar to the system 400 described above with reference to FIG. 4A. In one embodiment, if the message 402 specifies an intended recipient 102c, but the recipient determination module 204 determines that the intended recipient 102c is unavailable and the message 402 requests a response within a period of time, the recipient determination module 204 may identify a plurality of target recipients 102d, based on the context of the message 402 and the contextual information of target recipients within the organization, that have typical response times within the requested period of time for responding. The forwarding module 206 may then forward the message 402 to the target recipients 102d.

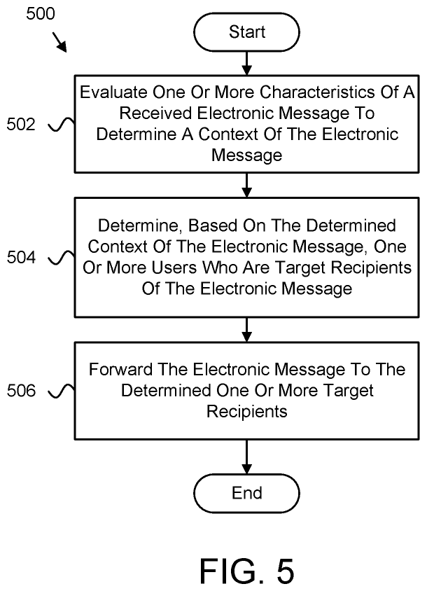

FIG. 5 is a schematic flow chart diagram illustrating one embodiment of a method 500 for dynamically determining recipients of electronic messages. In one embodiment, the method 500 begins and evaluates 502 one or more characteristics of a received electronic message to determine a context of the electronic message. The method 500, in further embodiments, determines 504, based on the determined context of the electronic message, one or more users who are target recipients of the electronic message. The method 500, in some embodiments, forwards 506 the electronic message to the determined one or more target recipients, and the method 500 ends. In one embodiment, the message evaluation module 202, the recipient determination module 204, and the forwarding module 206 perform the various steps of the method 500.

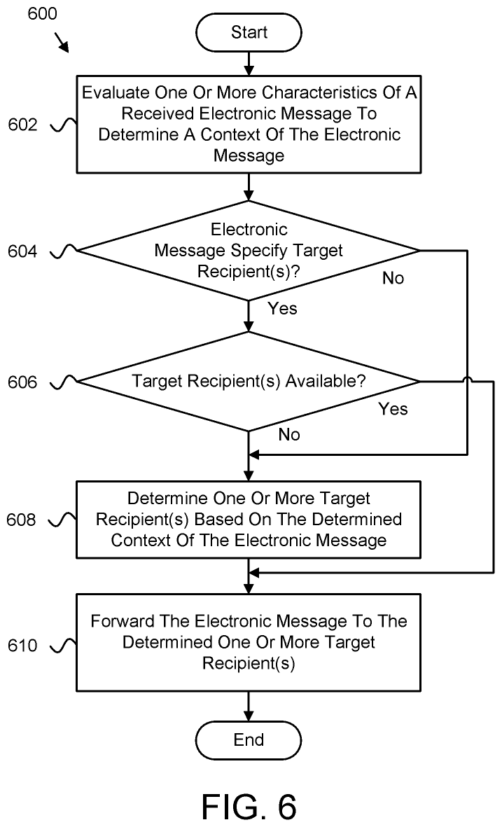

FIG. 6 is a schematic flow chart diagram illustrating one embodiment of another method 600 for dynamically determining recipients of electronic messages. In one embodiment, the method 600 begins and evaluates 602 one or more characteristics of a received electronic message to determine a context of the electronic message. In further embodiments, the method 600 determines 604 whether the electronic message specifies a target recipient. If not, then the method 600 may dynamically determine 608 one or more target recipients based on the context of the message.

Otherwise, the method 600 determines 606 whether the specified target recipient is available. If the specified target recipient is available, the method 600 forwards 610 the electronic message to the target recipient and the method 600 ends. Otherwise, the method 600 dynamically determines 608 one or more target recipients based on the context of the message and the method 600 forwards 610 the message to the one or more dynamically determined target recipients and the method 600 ends. In one embodiment, the message evaluation module 202, the recipient determination module 204, and the forwarding module 206 perform the various steps of the method 600.

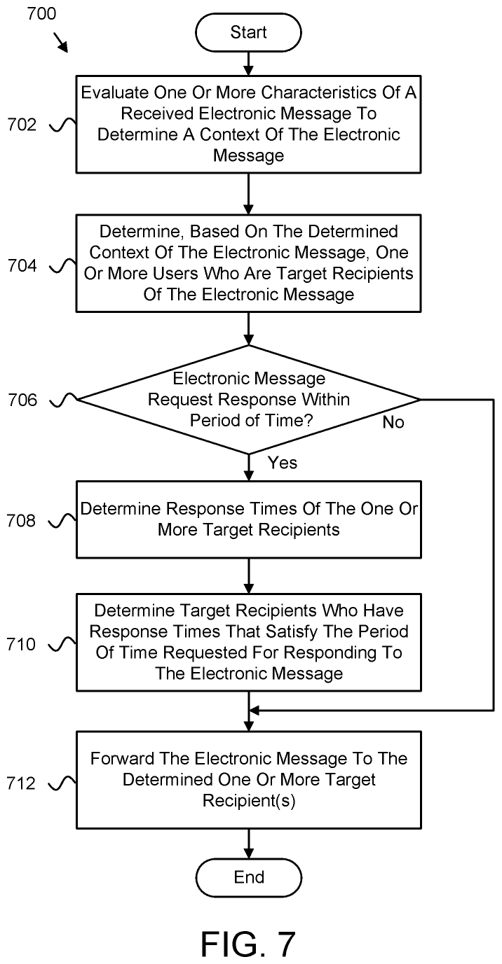

FIG. 7 is a schematic flow chart diagram illustrating one embodiment of yet another method 700 for dynamically determining recipients of electronic messages. In one embodiment, the method 700 begins and evaluates 702 one or more characteristics of a received electronic message to determine a context of the electronic message. The method 700, in further embodiments, determines 704, based on the determined context of the electronic message, one or more users who are target recipients of the electronic message.

In one embodiment, the method 700 determines 706 whether the electronic message includes a request for a response within a period of time. If not, the method 700 forwards 712 the electronic message to the determined one or more target recipients of the electronic message, and the method 700 ends. Otherwise, the method 700 determines 708 typical response times of the one or more target recipients (based on contextual information for the target recipients) and dynamically determines 710 target recipients who have response times that satisfy the period of time requested for responding to the electronic message. The method 700 may then forward 712 the electronic message to the determined one or more target recipients, and the method 700 ends. In one embodiment, the message evaluation module 202, the recipient determination module 204, and the forwarding module 206 perform the various steps of the method 700.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor; and
a memory that stores code executable by the processor to:
evaluate one or more characteristics of a received electronic message to determine a context of the electronic message;
determine, based on the determined context of the electronic message, one or more users who are target recipients of the electronic message; and
forward the electronic message to the determined one or more target recipients.

2. The apparatus of claim 1, wherein the code is further executable by the processor to:
determine that the electronic message specifies a target recipient for the electronic message;
determine that the specified target recipient is unavailable for receiving the message; and
select one or more different target recipients to forward the message to based on the determined context of the electronic message, a different target recipient selected in response to the determined context of the message matching contextual data associated with the different target recipient.

3. The apparatus of claim 2, wherein the specified target recipient is determined to be unavailable in response to:
the specified target recipient having an auto-reply message set up indicating that the specified target recipient is not available for a period of time; and/or
the specified target recipient is not located in a directory for the organization that the electronic message is sent to.

4. The apparatus of claim 1, wherein the code is further executable by the processor to determine the one or more target recipients of the electronic message based on a comparison of the determined context of the message and contextual data associated with the one or more target recipients.

5. The apparatus of claim 4, wherein the contextual data associated with the one or more target recipients comprises a department where the target recipient works within an organization, an education of the target recipient, professional experience for the target recipient, and/or a previous communication history of the target recipient with a sender of the electronic message.

6. The apparatus of claim 4, wherein the code is further executable by the processor to dynamically derive contextual data for a target recipient based on analyzing content of previous electronic messages sent to and/or from the target recipient.

7. The apparatus of claim 1, wherein the code is further executable by the processor to:
determine, based on the determined context of the electronic message, that the electronic message requests a response within a period of time;
determine typical response times for a plurality of potential target recipients of the electronic message; and
select the one or more target recipients from the plurality of target recipients for the electronic message in response to the one or more target recipients having typical response times that satisfy the period of time for responding to the electronic message.

8. The apparatus of claim 7, wherein a target recipient is selected from the plurality of potential target recipients in response to determining that the target recipient is available to respond to the electronic message.

9. The apparatus of claim 7, wherein the number of target recipients that are selected from the plurality of potential target recipients is inversely proportional to the period of time for responding to the electronic message.

10. The apparatus of claim 7, wherein the code is further executable by the processor to track, over time, the times for each of the plurality of potential target recipients for responding to a received electronic message and store the response times with other contextual data associated with each of the plurality of potential target recipients.

11. The apparatus of claim 1, wherein the code is further executable by the processor to:
prompt the one or more target recipients to confirm receiving the electronic message prior to forwarding the electronic message; and
forward the electronic message to one or more target recipients who confirm receiving the electronic message.

12. The apparatus of claim 1, wherein the code is further executable by the processor to notify a sender of the electronic message that the electronic message was forwarded to the one or more target recipients, the notification comprising contact information for each of the one or more target recipients.

13. A method comprising:
evaluating, by use of a processor, one or more characteristics of a received electronic message to determine a context of the electronic message;
determining, based on the determined context of the electronic message, one or more users who are target recipients of the electronic message; and
forwarding the electronic message to the determined one or more target recipients.

14. The method of claim 13, further comprising:
determining that the electronic message specifies a target recipient for the electronic message;
determining that the specified target recipient is unavailable for receiving the message; and
selecting one or more different target recipients to forward the message to based on the determined context of the electronic message, a different target recipient selected in response to the determined context of the message matching contextual data associated with the different target recipient.

15. The method of claim 13, further comprising determining the one or more target recipients of the electronic message based on a comparison of the determined context of the message and contextual data associated with the one or more target recipients, the contextual data being dynamically derived for a target recipient based on analyzing content of previous electronic messages sent to and/or from the target recipient.

16. The method of claim 13, further comprising:
determining, based on the determined context of the electronic message, that the electronic message requests a response within a period of time;
determining typical response times for a plurality of potential target recipients of the electronic message; and
selecting the one or more target recipients from the plurality of target recipients for the electronic message in response to the one or more target recipients having typical response times that satisfy the period of time for responding to the electronic message.

17. The method of claim 16, wherein a target recipient is selected from the plurality of potential target recipients in response to determining that the target recipient is available to respond to the electronic message.

18. The method of claim 16, wherein the number of target recipients that are selected from the plurality of potential target recipients is inversely proportional to the period of time for responding to the electronic message.

19. The method of claim 16, further comprising tracking, over time, the times for each of the plurality of potential target recipients for responding to a received electronic message and store the response times with other contextual data associated with each of the plurality of potential target recipients.

20. A program product comprising a computer readable storage medium that stores code executable by a processor, the executable code comprising code to:
evaluate one or more characteristics of a received electronic message to determine a context of the electronic message;
determine, based on the determined context of the electronic message, one or more users who are target recipients of the electronic message; and
forward the electronic message to the determined one or more target recipients.
